(19) United States
(12) Patent Application Publication
(10) Pub. No.: US 2026/0220518 A1
(43) Pub. Date: Jul. 30, 2026

(54) Selection of Quantum Sub-Circuit Implementations Based on Physical Metadata

(71) Applicant: Classiq Technologies LTD., Tel Aviv (IL)

(72) Inventors: Amir Naveh, Haifa (IL); Shmuel UR, Shorashim (IL); Gilad KISHONY, Haifa (IL); Avi ELAZARI, Hod-Hasharon (IL); Ron COHEN, Givataim (IL); Lior GAZIT, Tel-Aviv (IL); Yehuda NAVEH, Tel-Aviv (IL)

(21) Appl. No.: 19/005,366

(22) Filed: Dec. 30, 2024

(51) Int. Cl. G06N 10/70; G06N 10/20; G06N 10/80

(52) U.S. Cl. CPC G06N 10/70; G06N 10/20; G06N 10/80

(57) ABSTRACT

A method, apparatus and product comprising: obtaining a high-level representation of a quantum circuit composed of a plurality of sub-circuits; selecting a plurality of physical implementations for the plurality of sub-circuits, respectively, based on a library of metadata, said selecting comprising selecting a physical implementation for a sub-circuit based on metadata of the physical implementation, the metadata indicating a number of physical qubits and a number of physical cycles used by the physical implementation, said selecting comprising selecting the physical implementation from a plurality of alternative implementations of the sub-circuit, wherein the library comprises a respective plurality of metadata for the plurality of alternative implementations; and synthesizing the quantum circuit according to the plurality of physical implementations.

### TECHNICAL FIELD

The present disclosure relates to quantum computing in general, and to topological error correction in quantum computing, in particular.

### BACKGROUND

Quantum computing is a computational paradigm that is fundamentally different from classic computing. In contrast to classic computing, which utilizes bits, quantum computing utilizes qubits. The qubits have unique features, as each qubit can be in superposition, several qubits can be entangled, and all operations on qubits besides measurement (referred to as quantum gates) must be reversible.

Quantum Error Correction (QEC) may be configured to protect quantum information from errors due to decoherence and other quantum noise. Quantum error correction is essential for reducing noise of stored quantum information.

### BRIEF SUMMARY

One exemplary embodiment of the disclosed subject matter is a method comprising: obtaining a high-level representation of a quantum circuit, wherein the high-level representation is composed of a plurality of sub-circuits; selecting a plurality of physical implementations for the plurality of sub-circuits, respectively, based on a library of physical implementation metadata, said selecting comprising selecting a physical implementation for a sub-circuit from the plurality of sub-circuits based on metadata of the physical implementation, the metadata of the physical implementation indicating a number of physical qubits used by the physical implementation and a number of physical cycles used by the physical implementation, said selecting comprising selecting the physical implementation from a plurality of alternative implementations of the sub-circuit, wherein the library comprises a respective plurality of metadata for the plurality of alternative implementations; and synthesizing the quantum circuit according to the plurality of physical implementations, thereby obtaining a synthesized quantum circuit.

Optionally, said selecting the plurality of physical implementations is performed based on a global optimization calculation, the global optimization calculation comprises at least a hardware constraint on available physical qubits of a quantum execution platform.

Optionally, the global optimization calculation is configured to minimize at least one of: a number of cycles of the synthesized quantum circuit, a number of gates of the synthesized quantum circuit, a number of gates of a defined type used by the synthesized quantum circuit, an error rate of the synthesized quantum circuit, a number of physical qubits used by the synthesized quantum circuit, or a combination thereof.

Optionally, the global optimization calculation is configured to minimize a cost of glue code used to combine the plurality of physical implementations into the synthesized quantum circuit.

Optionally, the global optimization calculation is configured to comply with precedence constraints between the plurality of sub-circuits, and with a global error limit on the synthesized quantum circuit.

Optionally, the global optimization calculation defines a Constraint Satisfaction Problem (CSP) that corresponds to the high-level representation, the CSP comprises variables, domains and constraints, each variable of the variables has a corresponding domain in the domains that defines one or more potential values of the variable, the constraints define one or more constraints on values of the variables or portion thereof, the constraints comprise the precedence constraints, the global error limit, and the hardware constraint; and the method further comprises generating the synthesized quantum circuit by utilizing a CSP solver to solve the CSP, wherein a solution of the CSP defines a selection of a plurality of library entries from the library, the plurality of library entries corresponds to the plurality of physical implementations.

Optionally, the sub-circuit is implementable by the plurality of alternative physical implementations, each of which implementing the sub-circuit and resulting with different metadata, the plurality of alternative physical implementations comprises at least the physical implementation and a second physical implementation.

Optionally, the library comprises at least second metadata regarding the second physical implementation of the sub-circuit, wherein the second metadata indicates a second number of physical qubits used by the second physical implementation and a second number of physical cycles used by the second physical implementation, wherein the second metadata differs from the metadata of the physical implementation in at least one parameter.

Optionally, the library is absent of inferior metadata entries for the sub-circuit that indicate inferior performance properties in all parameters compared to at least one metadata entry for the sub-circuit.

Optionally, said synthesizing comprises retrieving the physical implementation from a storage associated with the library.

Optionally, said selecting the physical implementation comprises selecting a data point from a line chart, the line chart representing a tradeoff of physical qubits per physical cycles for alternative physical implementations of the sub-circuit, wherein said synthesizing comprises dynamically generating the physical implementation for the data point.

Optionally, the high-level representation comprises a Directed Acyclic Graph (DAG), wherein nodes of the DAG represent the plurality of quantum operations, wherein edges between the nodes represent precedence constraints between the plurality of quantum operations, wherein each sub-circuit of the plurality of sub-circuits comprises at least one disjoint node of the nodes.

Optionally, the high-level representation comprises a high-level quantum program composed of a plurality of functions, wherein each sub-circuit of the plurality of sub-circuits comprises at least one disjoint function of the plurality of functions.

Optionally, said selecting is performed based on the metadata of the physical implementation and is agnostic to implementation details of the plurality of alternative implementations.

Optionally, the method comprises executing the synthesized quantum circuit on a quantum execution platform.

Another exemplary embodiment of the disclosed subject matter is an apparatus comprising a processor and coupled memory, said processor being adapted to: obtain a high-level representation of a quantum circuit, wherein the high-level representation is composed of a plurality of sub-circuits; select a plurality of physical implementations for the plurality of sub-circuits, respectively, based on a library of physical implementation metadata, said selecting comprising selecting a physical implementation for a sub-circuit from the plurality of sub-circuits based on metadata of the physical implementation, the metadata of the physical implementation indicating a number of physical qubits used by the physical implementation and a number of physical cycles used by the physical implementation, said selecting comprising selecting the physical implementation from a plurality of alternative implementations of the sub-circuit, wherein the library comprises a respective plurality of metadata for the plurality of alternative implementations; and synthesize the quantum circuit according to the plurality of physical implementations, thereby obtaining a synthesized quantum circuit.

Yet another exemplary embodiment of the disclosed subject matter is a computer program product comprising a non-transitory computer readable medium retaining program instructions, which program instructions when read by a processor, cause the processor to: obtain a high-level representation of a quantum circuit, wherein the high-level representation is composed of a plurality of sub-circuits; select a plurality of physical implementations for the plurality of sub-circuits, respectively, based on a library of physical implementation metadata, said selecting comprising selecting a physical implementation for a sub-circuit from the plurality of sub-circuits based on metadata of the physical implementation, the metadata of the physical implementation indicating a number of physical qubits used by the physical implementation and a number of physical cycles used by the physical implementation, said selecting comprising selecting the physical implementation from a plurality of alternative implementations of the sub-circuit, wherein the library comprises a respective plurality of metadata for the plurality of alternative implementations; and synthesize the quantum circuit according to the plurality of physical implementations, thereby obtaining a synthesized quantum circuit.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows an exemplary flowchart diagram of a method, in accordance with some exemplary embodiments of the disclosed subject matter;

FIGS. 2A-2C show exemplary scenarios of implementation selections, in accordance with some exemplary embodiments of the disclosed subject matter;

FIG. 3 show an exemplary line chart, in accordance with some exemplary embodiments of the disclosed subject matter;

FIG. 4 shows an exemplary physical implementation of a sub-circuit, in accordance with some exemplary embodiments of the disclosed subject matter; and

FIG. 5 shows an exemplary block diagram of an apparatus, in accordance with some exemplary embodiments of the disclosed subject matter.

### DETAILED DESCRIPTION

One technical problem dealt with by the disclosed subject matter is to provide efficient physical implementations of high-level quantum programs (also referred to as “high-level quantum circuits”), that incorporate an error correction scheme.

In some exemplary embodiments, quantum error correction may be necessary for quantum computing, e.g., due to the decoherence property of qubits, which causes qubits to lose their quantum properties quickly in the presence of a constant amount of noise per qubit. In some exemplary embodiments, quantum errors may also result from qubit initialization, measurement errors, qubit loss, qubit leakage, or the like. In some cases, errors in the qubit state probability amplitudes may propagate rapidly, if not corrected, causing the qubit state to become unusable. In some exemplary embodiments, one or more quantum error correction codes may be deployed in order to correct quantum state errors, such as stabilizer codes, topological error correction codes, or the like. For example, topological error correction codes may comprise a surface code technique.

In some exemplary embodiments, high-level quantum programs may be designed, programmed or created by a user, a programmer, an operator, or the like, using functional-level code, using evolutionary computing techniques such as Quantum Genetic Algorithm (QGA), using genetic algorithms, or the like. In some exemplary embodiments, a high-level representation of a quantum circuit may be absent of any non-native gates. In some exemplary embodiments, a high-level quantum program may comprise a graph, such as a Directed Acyclic Graph (DAG), in which each node represents one or more quantum operations, and each edge represents precedence constraints between the quantum operations. For example, the precedence constraints may indicate that an operation represented by the first node must be executed before an operation represented by a second node. In some cases, a high-level quantum program may be representable by any other representation, graph or form.

In some exemplary embodiments, after an initial high-level quantum program is created, it may be processed by one or more processing units to become an executable quantum circuit that can be executed on a quantum computer, a quantum cloud, a quantum execution platform, or the like. For example, the compilation stages may convert the high-level representation to one or more intermediate logical representations that comprise logical qubits, logical cycles, or the like. In some exemplary embodiments, during a compilation stage, a physical representation for the high-level quantum program may be generated to implement the high-level representation, e.g., using a quantum error correction code such as surface code. In some exemplary embodiments, the physical representation of the quantum circuit may relate to physical qubits of a quantum execution platform, physical gates, physical cycles, schedules thereof, allocations thereof, or the like.

In some cases, quantum error correcting code may be implemented by a quantum execution platform (e.g., a quantum computer) in order to spread information of at least one logical qubit onto a highly entangled state of several physical qubits. In some exemplary embodiments, this may enable to store the information of the logical qubit onto a highly entangled state of the physical qubits. For example, a topological error correction scheme, such as surface code or color code, may achieve quantum error correction by spreading information of one or more logical qubits onto a set of physical qubits. As an example, surface code may comprise an error correction scheme in which logical qubits are represented by respective sets of physical qubits, while enabling operations between the logical qubits, as disclosed, for example, in Fowler et al. “Surface codes: Towards practical large-scale quantum computation” Phys. Rev. A 86, 032324 (18 Sep. 2012), which is hereby incorporated by reference in its entirety for all purposes without giving rise to disavowment. In some exemplary embodiments, syndrome measurements may be used to determine whether a physical qubit state has been corrupted, enabling the correction of such errors.

In some exemplary embodiments, a high-level quantum program may be implementable by different alternative physical implementations of the quantum circuit. In some exemplary embodiments, each alternative physical representation of the quantum circuit may comprise a plurality of physical qubits that are manipulated by a plurality of physical gates over a plurality of cycles, according to a schedule. In some exemplary embodiments, each alternative physical representation may be composed of native gates.

In some exemplary embodiments, the alternative physical implementations may implement the same high-level representation in a different manner, e.g., using a different number of qubits, cycles, and/or gates, using different types of qubits and/or gates, using a different order of gate application, or the like. For example, a high-level quantum program may be convertible to two different logical representations, and these, in turn, may each be convertible to a plurality of different physical implementations.

In some exemplary embodiments, the alternative physical implementations may implement the same high-level representation in a different manner, e.g., using different error correction schemes. In some exemplary embodiments, within a same error correction scheme, such as surface code, the high-level representation may be implementable by different alternative physical representations of the quantum circuit, all of which implement the same high-level representation in a different manner within the surface code framework. For example, alternative physical implementations may use different numbers and/or types of T-factories, different sizes and types of qubit patches, different layouts and size of auxiliary patches, a different number of physical cycles, a different number of physical qubits, or the like. In some exemplary embodiments, the qubit patches, auxiliary patches, and T-factory patches may correspond to those disclosed in U.S. Pat. No. 18,932,175 A1, titled “DESIGNING QUANTUM CIRCUITS WITH TOPOLOGICAL ERROR CORRECTION”, filed Oct. 30, 2024, which is hereby incorporated by reference in its entirety for all purposes without giving rise to disavowment (hereinafter the “topological design method”).

In some exemplary embodiments, alternative implementations of a high-level representation may result with different error rates, different execution times, different resource utilizations, or the like. For example, different physical implementations may allocate different indexes of physical qubits for representing each logical qubit of the high-level representation using the surface code. As another example, different physical implementations may allocate a different number of physical qubits for each logical qubit. As another example, different physical implementations may utilize a different overall quantity of physical qubits. As another example, different physical implementations may order gate operations differently, implement logical gates differently, or the like.

In some exemplary embodiments, the different physical implementations may all be required to comply with the same constraints, e.g., precedence constraints between at least a subset of the quantum operations, hardware constraints of the execution platform, an error limit, or the like. For example, hardware constraints may comprise a number of available physical qubits on the execution platform, an overall number of physical qubits on the execution platform, quantum operations and/or gates that are applicable by the execution platform, T-factories that can be implemented by the platform, or the like.

It may be desired to select, from the alternative physical implementations, an implementation of the high-level representation that is both efficient, and incorporates an error correction scheme.

Another technical problem dealt with by the disclosed subject matter is to provide an efficient physical implementation of a quantum program, that incorporates a topological error correction scheme.

In some exemplary embodiments, topological error correction codes, such as surface code, may constitute a class of quantum error correction codes that relies on the topology of a two-dimensional lattice, a plane, a connectivity graph, or the like (referred to hereinafter as “lattice” or “plane”), which defines the connectivity of the physical qubits. When implementing surface code, the entire lattice, or portions thereof, may be used to represent one or more logical qubits of the high-level representation and to apply thereon quantum operations according to the high-level representation. For example, topological surface code architectures may be employed to periodically correct qubits. In some cases, physical qubits of a quantum computer may be allocated to “qubit patches” that host or represent logical qubits of the high-level representation, to “auxiliary patches” that represent quantum operations, and “T-factory” patches that represent T-factories. In some cases, the patches may correspond at least in part to the patches disclosed in the topological design method, and/or in D. Litinski. “A Game of Surface Codes: Large-Scale Quantum Computing with Lattice Surgery”. arXiv:1808.02892 (2018). arxiv.org/abs/1808.02892, which is hereby incorporated by reference in its entirety for all purposes without giving rise to disavowment.

In some cases, a qubit patch may comprise physical qubits that represent a single logical qubit, or a plurality of logical qubits. For example, qubit patches may comprise one-qubit patches, two-qubit patches, or the like. In some cases, an “auxiliary patch” may comprise a path of physical qubits formed in an intermediate auxiliary region between qubit patches, T-factory patches, or the like (e.g., to apply gates, obtain T-states, perform measurements, or the like). In some cases, one or more T-factory patches may comprise physical qubits allocated to one or more T-factories, T-state producers, or the like, and may be used to create universal states such as magic states or T-states.

It may be desired to select, from the alternative physical implementations of a quantum program, an implementation that is both efficient, and incorporates a topological error correction scheme.

Yet another technical problem dealt with by the disclosed subject matter is to select, from alternative physical implementations of a quantum program, an implementation that is optimal. In some exemplary embodiments, an implementation that is optimal may comprise an implementation optimizing in parameters such as execution time, a number of utilized physical qubits, an error rate, a combination thereof, a defined ratio between them, minimizing one parameter while adhering to a limit on another parameter, or the like.

It is noted that the term ‘optimal’ or ‘optimized’, as used herein, may refer to a solution that complies with one or more thresholds or constraints, falls within a defined range of sufficiently favorable results, is within a specific percentile of results, or the like.

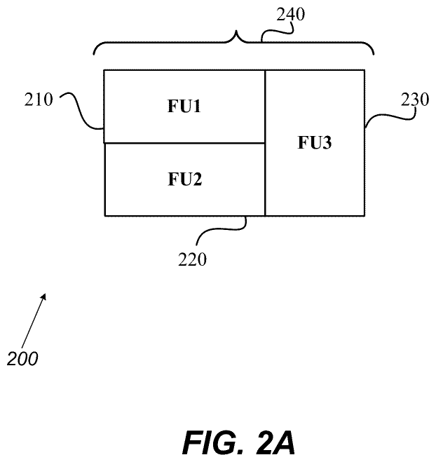

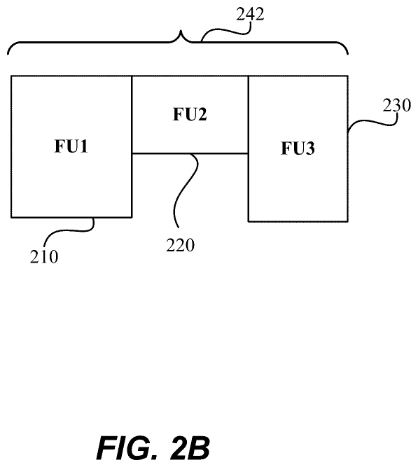

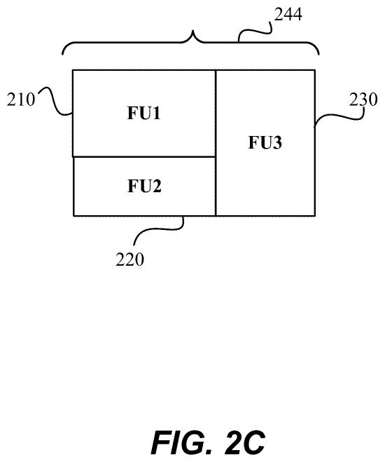

In some exemplary embodiments, some methods for generating physical implementations of a quantum program, rely on selecting implementations for sub-elements of the quantum program using greedy calculations, and then combining the implementations to form an aggregated quantum circuit. In some cases, selecting locally optimized implementations for sub-elements of the quantum program may not always provide a global, or overall, optimization. For example, local optimizers may not take into global parameters such as parallel or subsequent executions, precedence constraints between sub-circuits, or the like, e.g., as depicted in FIG. 2B.

It may be desired to overcome this challenge, and select physical implementations for sub-circuits that are globally efficient for entire quantum program.

Yet another technical problem dealt with by the disclosed subject matter is to select, from alternative physical implementations of a quantum program, an implementation of a quantum program that takes into account precedence constraints between sub-circuits. For example, it may be desired to ensure that the global optimization will take into account precedence constraints and dependencies between subcircuits of a quantum program, e.g., between DAG nodes of a DAG representing the quantum program.

Yet another technical problem dealt with by the disclosed subject matter is to integrate different physical implementations of sub-circuits (e.g., each sub-circuit including one or more DAG nodes), in an optimized manner. In some exemplary embodiments, the integration of subcircuits may add an additional layer of complexity, as different implementations of subcircuits may utilize different error correction parameters, such as different sizes of qubit patches. It may be desired to provide a physical implementation of a quantum program that implements and integrates all of the implementations of its sub-circuits efficiently.

Yet another technical problem dealt with by the disclosed subject matter is to enhance the process of converting a high-level representation of a circuit to a physical implementation. For example, it may be desired to reduce the number of compilation stages and the resources allocated for compilation stages, reduce the time consumption of the process, or the like.

One technical solution provided by the disclosed subject matter is selecting a physical implementation for high-level quantum program, based on metadata regarding alternative physical implementations of each sub-circuit of the quantum program. In some exemplary embodiments, the metadata may be processed and used to determine a selection that complies with global optimization objectives, constraints, or the like.

In some exemplary embodiments, a sub-circuit of the quantum program may comprise a function of the quantum program, at least one node of a DAG representing the quantum program, or the like. In some exemplary embodiments, each sub-circuit may correspond to a plurality of physical implementations, all of which implementing the functionality of the sub-circuit using different resources, schedules, logical representations, or the like. For example, first and second logical representations of a sub-circuit may utilize different gates, a different order of applying gates, a different number of auxiliary qubits, cycles, or the like, while achieving the same output state. As another example, first and second physical implementations of a sub-circuit may implement a topological error correction code using different allocations of physical qubits to patches, using a different number of cycles, or the like, while achieving the same output state.

In some exemplary embodiments, physical implementations of a sub-circuit may correspond to one or more logical representations thereof. In some exemplary embodiments, a logical representation may comprise a plurality of logical qubits that are manipulated by a plurality of logical gate operations.

In some exemplary embodiments, the selection of physical implementations of sub-circuits may be performed without relating to implementation details. In some exemplary embodiments, instead of compiling the quantum program to determine one or more intermediate logical representations thereof, and converting the logical implementations to physical implementations using one or more optimization methods, the disclosed subject matter determines a selection of physical implementations that does not depend on the implementation details, e.g., without basing the selection on the corresponding logical representations, the gate schedule, the size of patches, or the like.

In some exemplary embodiments, instead of selecting physical implementations according to their implementation details, the selection of physical implementations of sub-circuits may be performed based on metadata regarding physical implementations of the sub-circuits, bypassing the compilation stages.

In some exemplary embodiments, metadata regarding a physical implementation of a sub-circuit may comprise performance parameters of the physical implementation, properties of the physical implementation, or the like. For example, the metadata may comprise a number of physical qubits that are needed by the physical implementation, a number of cycles of the physical implementation, a number of T-factories used by the physical implementation, an error rate incurred by the physical implementation, or the like.

In some exemplary embodiments, metadata regarding a physical implementation of a sub-circuit may be accumulated based on measurements of the physical implementation, simulations thereof, approximations thereof, or the like. In some exemplary embodiments, metadata regarding physical implementations of the sub-circuits may be accumulated, obtained, or the like, and stored in a library. For example, the library may store, for each available physical implementation, its number of physical cycles and number of physical qubits.

In some exemplary embodiments, a physical implementation of a sub-circuit may be considered “available” in the library in case a synthesized and executable version of the physical implementation is stored at an accessible location that is accessible to the execution platform (e.g., locally, at a server, or the like). In some exemplary embodiments, a physical implementation of a sub-circuit may be considered available in case a synthesizing function is available in the library, and is capable of generating the physical implementation according to its metadata properties upon request. For example, the synthesizing function may be configured to synthesize an implementation of a sub-circuit, according to defined resource configurations (e.g., a specified number of physical qubits and cycles), and to output a physical implementation that complies with the resource configurations. In some exemplary embodiments, the implementation details of the physical implementation may be redundant for the selection process, as long as the physical implementation complies with the defined resource configurations. For example, the physical implementation may be required to utilize the exact number of physical qubits and cycles defined by the resource configurations, not more or less.

In some exemplary embodiments, the library may be generated to store, for each sub-circuit, metadata regarding one or more available physical implementations thereof.

In some exemplary embodiments, each alternative physical implementation of a sub-circuit may differ in at least one resource configuration. For example, a first physical implementation of a function (e.g., a sub-circuit) may comprise a size of 72,000 physical qubits (for the entire design, including a single T-factory patch of size 8,000), and a number of cycles of 200,000. A second physical implementation of the same function may comprise a size of 80,000 physical qubits (for the entire design, including two T-factory patches of size 8,000 each), and a number of cycles of 110,000.

In some exemplary embodiments, metadata regarding available physical implementations of a sub-circuit may only be added as library entries or records to the library in case the implementations are “non-inferior” physical implementations. In some exemplary embodiments, “non-inferior” physical implementations may refer to physical implementations that do not underperform in both cycle count and qubit usage, compared to other available implementations.

For example, in case a first physical implementation of a sub-circuit utilizes 50 physical qubits and 50 cycles, and a second physical implementation of the same sub-circuit utilizes 100 physical qubits and 100 cycles, the second physical implementation underperforms in both parameters, and thus is inferior to the first physical implementation. According to this example, metadata regarding the second physical implementation may not be added to the library. As another example, in case a first physical implementation of a sub-circuit utilizes 50 physical qubits and 100 cycles, and a second physical implementation of the same sub-circuit utilizes 100 physical qubits and 50 cycles, neither are inferior to the other in both parameters, since each implementation has an advantage in at least one parameter over the other. According to this example, metadata regarding both physical implementations may be added to the library.

In some exemplary embodiments, metadata regarding available physical implementations of a sub-circuit may only be added to the library in case they are not identical. For example, two different physical implementations of a sub-circuit that relate to different logical implementations of the sub-circuit, that incorporate a different internal configuration of the error correction scheme, or the like, may have the same metadata, e.g., a same overall number of physical cycles, physical qubits, error rate, or the like. In such cases, only a single entry of metadata regarding one of the available physical implementations of the sub-circuit may be added to the library, e.g., randomly, according to heuristics, defined settings, or the like.

In some exemplary embodiments, metadata regarding available physical implementations of a sub-circuit may only be added to the library in case the metadata, or performance parameters, are verified, tested, statistically measured, approximated with a high confidence score, or the like.

In some exemplary embodiments, the library may be used to select a physical implementation for each sub-circuit of a quantum program, according to global parameters, global optimization calculations, or the like. In some exemplary embodiments, the global parameters may correspond to performance parameters of an aggregated circuit, composed from physical implementations of each sub-circuit. In some exemplary embodiments, the aggregated circuit may comprise an approximated circuit in which all gates are native gates. For example, the global parameters may comprise an execution time of the aggregated circuit, a number of physical qubits utilized by the aggregated circuit, an error rate of the aggregated circuit, or the like.

In some exemplary embodiments, the global parameters may comprise global constraints, such as hardware constraints of a target quantum execution platform, precedence constraints between sub-circuits (e.g., as indicated by the DAG), error rate constraints or limits, considerations that relate to interconnections between physical implementations, or the like. In some exemplary embodiments, the global optimization calculation may be configured to select physical implementations that optimize global parameters of a resulting circuit globally, while complying with the global constraints.

In some exemplary embodiments, the global parameters may comprise an objective function that is configured to minimize a cost function. The cost function may measure an estimated number of cycles of the aggregated circuit, the number of physical qubits allocated to the aggregated circuit, the error rate of the aggregated circuit, the cost of any required application of “glue” code between two consecutive physical implementations, or the like.

In some cases, the error rate of the aggregated circuit may depend, in many cases, on the number of cycles of the aggregated circuit, and on a number of idle cycles in which a set of qubits are idle. In some exemplary embodiments, the number of cycles, and the number of idle cycles, may be linearly correlated with the error rate. For example, an increase in the number of cycles may increase the error rate. In some cases, minimizing the number of cycles and/or the number of idle cycles, may correspond to minimizing the error rate. In some cases, the cost function may measure the number of cycles of the aggregated circuit, e.g., as a single or main parameter, thereby attempting to reduce the execution time on the expense of using more physical qubits.

In some exemplary embodiments, one or more constraint solvers, such as a Constraint Satisfaction Problem (CSP) solver, search algorithms, or the like, may be used to select physical implementations of sub-circuit that comply with the global constraints (e.g., precedence constraints) and optimize the objective function. For example, the objective function may be configured to minimize the overall number of cycles of the aggregated circuit. In some exemplary embodiments, the selection may be performed by generated a CSP that represents the different potential selections of library entries, and by solving the CSP using a CSP solver, e.g., as disclosed in U.S. patent application Ser. No. 17/499,046 filed Oct. 12, 2021, titled “CSP-BASED SYNTHESIS OF A QUANTUM CIRCUIT”, which is herein incorporated by reference in its entirety without giving rise to disavowment (“CSP generation method”).

For example, in case the precedence constraints indicate that two sub-circuits can be executed in parallel, two respective physical implementations that implement the sub-circuits may be selected such that their executions end at the same time, with a minimized time gap, or the like, e.g., thereby reducing idle cycles. As another example, in case the precedence constraints indicate that two sub-circuits can be executed in parallel, two respective physical implementations that implement the sub-circuits may be selected such that their executions end as early as possible, even if idle cycles are incurred.

In some exemplary embodiments, parallel executions of physical implementations may be scheduled while ensuring they comply with a global constraint on physical qubits. For example, if an execution platform indicates that the execution platform has 200 available physical qubits, all physical implementations that are executed in parallel on the execution platform may have a global constraint of 200, indicating that the sum of the physical qubits utilized by the parallel executions must be less or equal to 200.

In one scenario, precedence constraints between sub-circuits may indicate that a first sub-circuit must be executed after second and third sub-circuits complete their execution (e.g., in case the first sub-circuit manipulates outputs from the second and third sub-circuits). In such a case, the number of available physical qubits, represented as a global constraint, may be divided between the second and third sub-circuits, to allow them to be executed in parallel, and the available physical qubits may be re-allocated to the first sub-circuit upon completion of the executions of the second and third sub-circuits.

According to this scenario, physical implementations of the second and third sub-circuits may be selected from the library in case they reduce the number of cycles as much as possible while complying with the global constraints. For example, physical implementations of the second and third sub-circuits may be selected to include the maximal number of physical qubits that complies with the global constraint on physical qubits. As another example, physical implementations of the second and third sub-circuits may be selected in case they comply with a global constraint on an error rate, such that the total error rate of the aggregated circuit complies with an error rate limit. As another example, physical implementations may be selected such that they optimize on the number of cycles and comply with the global constraints (e.g., using a CSP solver).

In some exemplary embodiments, after selecting from the library physical implementations for each sub-circuit, the physical implementations may be obtained, generated, retrieved, or the like, and used to create a synthesized aggregated circuit. For example, the physical implementations may be obtained from the library, from a separate storage, may be dynamically generated, or the like.

In some exemplary embodiments, the physical implementations may be combined and/or aggregated to generate a physical quantum circuit. In some exemplary embodiments, in case consecutive physical implementations of sub-circuits that are selected for the aggregated circuit differ in properties of their error correction scheme, such as in the size of their qubit patches, “glue” code may be used to coordinate interactions between the separate implementations and ensure integration during execution. For example, glue code may be applied between implementations using swap chain, to coordinate differences such as surface code size changes.

One technical effect obtained by the disclosed subject matter is providing a direct compilation process, from a high-level quantum program to an aggregated physical circuit, without processing or analyzing any implementation details of sub-elements of the program. By selecting physical implementations based on their metadata, regardless of the implementation details, the processing stages are reduced, saving computational resources and time compared to indirect compilation processes. In some exemplary embodiments, in case the selected physical implementations are pre-prepared implementations from a library, the compilation speed may be greatly enhanced, at least since the synthesizing stage may be bypassed.

Another technical effect obtained by the disclosed subject matter is providing a library of metadata entries, that enables to perform a direct compilation process with global optimization.

Yet another technical effect obtained by the disclosed subject matter is providing an efficient implementation of a quantum program, that optimizes on global objective functions, complies with global constraints, or the like.

Yet another technical effect obtained by the disclosed subject matter is utilizing optimizers such as CSP solvers to optimize implementation selections for a quantum program.

Yet another technical effect obtained by the disclosed subject matter is utilizing optimizers such as CSP solvers to select, for each sub-circuit of a quantum program, physical implementations such that a resulting quantum circuit has a minimal number of cycles. The disclosed subject matter may provide for one or more technical improvements over any pre-existing technique and any technique that has previously become routine or conventional in the art. Additional technical problems solutions and effects may be apparent to a person of ordinary skill in the art in view of the present disclosure.

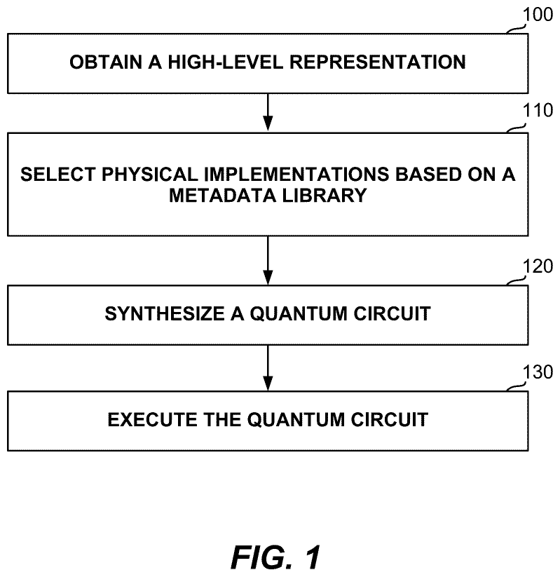

Referring now to FIG. 1, showing an exemplary flowchart diagram of a method, in accordance with some exemplary embodiments of the disclosed subject matter.

On Step 100, a high-level representation of a quantum circuit may be obtained, e.g., as an input. In some exemplary embodiments, the high-level representation may be absent of native gates, e.g., thereby being of high-level. In some exemplary embodiments, the high-level representation may comprise a quantum program with a plurality of functions, a DAG with a plurality of nodes, or the like. For example, the nodes of the DAG may represent a plurality of gate operations, and the edges between the nodes may represent precedence constraints between the plurality of gate operations. In some exemplary embodiments, precedence constraints of the quantum circuit may be represented in any other way.

In some exemplary embodiments, the high-level representation may be obtained from a programmer, from a user, from local storage, from remote storage, from an execution platform, from a compiler or process of the execution platform, from a remote device via computer communications, or the like. In some exemplary embodiments, in some cases, the high-level representation may be obtained together with one or more additional parameters, e.g., an error limit, error threshold, or the like. For example, the error limit may indicate a limit requirement for a physical quantum circuit that implements the high-level representation.

In some exemplary embodiments, the high-level representation may be composed of a plurality of sub-circuits. For example, each sub-circuit may correspond to one or more nodes of a DAG representing the quantum circuit, to one or more functions of a quantum program, or the like. In some exemplary embodiments, each sub-circuit may have known properties such as a minimal number of T-states used by the sub-circuit, a minimal number of physical qubits used by the sub-circuit, or the like.

In some exemplary embodiments, the quantum circuit may be scheduled to be executed by a quantum execution platform, such as a quantum computer, a quantum cloud, or the like. In some exemplary embodiments, the quantum computer may comprise a set of physical qubits positioned on a lattice, plane, connectivity graph, surface or the like, which may be embedded in at least two dimensions. For example, the quantum execution platform may comprise a plurality of physical qubits represented as a lattice of two dimensions, three dimensions, or the like. In some exemplary embodiments, the plane may comprise a mapping of physical connectivity links between each pair of physical qubits of the set of physical qubits (e.g., a connectivity map). In some exemplary embodiments, each two physical qubits may be either connected or not connected, e.g., physically via wires.

In some exemplary embodiments, sub-circuits of the quantum circuit may be implementable on the quantum execution platform by a plurality of alternative physical representations of the quantum circuit. In some exemplary embodiments, each alternative physical representation may implement the sub-circuit in a different way, e.g., with a different allocation of Physical Qubits (PQs) to qubits patches, a different allocation of PQs to auxiliary patches, a different allocation of PQs to T-factories, a different mapping of Logical Qubits (LQs) to qubit patches, a different dynamic adjustment of the allocation, a different overall number of PQs that are used, or the like.

On Step 110, a selection process may be performed to select, for each sub-circuit of the high-level representation, a physical implementation. In some exemplary embodiments, the selection process may be performed based on a global optimization calculation, e.g., a global optimization function, global constraints, or the like.

In some exemplary embodiments, the selection process may implement a direct compilation from a high-level representation of a quantum circuit, such as a high-level quantum program, to a physical representation composed of native gates. In some exemplary embodiments, the selection process may comprise a selection of physical implementations for the sub-circuits of the high-level representation. In some exemplary embodiments, the physical implementations for the sub-circuits may be selected from a library. In some exemplary embodiments, the library may comprise a locally stored library, a cloud-based library, a remote accessible library, a combination thereof, or the like.

In some exemplary embodiments, the library may be generated to comprise one or more pre-prepared library entries for each sub-circuit of the high-level representation. In some exemplary embodiments, each library entry for a sub-circuit may comprise metadata associated with a respective physical implementation of the sub-circuit. In some exemplary embodiments, the metadata of each physical implementation of the sub-circuit may indicate a number of physical cycles, a number of physical qubits, a number of T-factories, error rates, or the like, associated with the respective physical implementation. In other cases, any other performance properties may be included in the metadata.

In some exemplary embodiments, each library entry of a sub-circuit, representing a respective function or DAG node, may relate to an independent implementation of the sub-circuit. For example, metadata regarding a sub-circuit may measure a performance of a physical implementation of the sub-circuit that does not implement any other sub-circuit of the circuit.

In some exemplary embodiments, the error correction scheme used for different library entries may differ. In some cases, a first sub-circuit may be implemented using a different error correction framework than a second sub-circuit, e.g., as they may be selected independently. In some cases, a first library entry for a sub-circuit may be implemented using a different error correction framework than a second library entry for the same sub-circuit. For example, a first library entry may utilize one-qubit patches for its error correction framework, while a second library entry may utilize two-qubit patches for its error correction framework. As another example, a first library entry may utilize two T-factory patches for its error correction framework, while a second library entry may utilize five T-factory patches for its error correction framework. As another example, a first library entry may utilize auxiliary patches with full all-to-all connectivity for its error correction framework, while a second library entry may utilize auxiliary patches that lack all-to-all connectivity for its error correction framework.

In some exemplary embodiments, the metadata may not necessarily indicate an internal allocation of resources. For example, metadata of a physical implementation may indicate a number of physical qubits, without indicating a number or position of T-factories to which a sub-set of the physical qubits is allocated, without indicating a size or structure of qubit patches in terms of physical qubits, without indicating a size or structure of auxiliary patches in terms of physical qubits, without indicating a type of T-factories used, without indicating an error correction framework that is used, or the like. In other cases, one or more internal allocation of resources may be indicated by the metadata. For example, the number of T-factories in the physical implementation may be indicated by the metadata.

In one scenario, metadata associated with physical implementations of a sub-circuit may be presented as tabular data, e.g., according to Table 1. In other cases, library entries may be stored and presented in any other format or manner, e.g., as a string, graph, document, or the like. For example, Table 1 shows exemplary metadata entries for a sub-circuit, which may or may not be added, fully or partially, to the library.

TABLE 1

| Number of T- | Total design size in | Total time in | |
|---|---|---|---|
| Factories | physical qubits | cycles | Error |
| 1 | 72000 | 200000 | .0009 |
| 2 | 80000 | 110000 | .0007 |
| 3 | 88000 | 70000 | .0005 |
| 4 | 96000 | 65000 | .00048 |
| 5 | 104000 | 63000 | .00047 |

As shown in Table 1, each metadata entry of the table (e.g., each row) incorporates properties, or performance parameters, of different physical implementations of the same sub-circuit. For example, each entry may indicate values of parameters such as the number of T-factories used by the respective implementation, the total number of physical qubits used by the respective implementation, the number of cycles used by the respective implementation, and the error rate of the respective implementation. In other cases, the number of T-factories may be omitted. For example, since the physical qubits used to implement the T-factories are included in the “Total design size in physical qubits” column, the “Number of T-Factories” column may be redundant.

As shown in Table 1, none of the entries may be dominant over other entries, at least since each entry may represent a different tradeoff between cycles and physical qubits. In some cases, a metadata entry of Table 1 may be added to the library, e.g., in case there does not exist a dominant implementation of the sub-circuit that overperforms the metadata entry. In some cases, a metadata entry of Table 1 may be added to the library without the “Number of T-Factories” column, e.g., since this may be incorporated in the “Total design size in physical qubits” column.

In some exemplary embodiments, the metadata entries may indicate a tradeoff between the number of physical qubits and the number of cycles. As depicted in Table 1, the number of physical qubits is negatively correlated with the number of cycles. For example, the first row depicts a scenario in which the number of physical qubits used for the entire sub-circuit implementation, including the T-factory, is 72,000, resulting with 200,000 cycles. This can be the case, for example, when the T-factory has a size of 8000 PQs, and a single T-factory is used. As another example, in case two T-factories are used, such as in the case of the second row of Table 1, the number of physical qubits used for the entire sub-circuit implementation may be increased by an additional 8000 PQs, reaching 80,000 PQs, while reducing the number of cycles to 110,000 cycles (e.g., since the number of T-factories may be oppositely correlated to the number of cycles).

In some exemplary embodiments, physical implementations may be pre-prepared and stored in the library, in a linked database, repository, or the like, e.g., in association with the respective library entries. In some exemplary embodiments, library implementations may be pre-prepared and stored separately from the metadata in the library, such as along with a retrievable identifier to enable swift retrieval of physical implementations associated with selected library entries.

In some exemplary embodiments, implementations of a sub-circuit may be generated dynamically as needed, rather than relying on static pre-made library entries. In some exemplary embodiments, physical implementations may be dynamically generated in response to a selection of desired tradeoff between physical qubits and cycles, e.g., which may be stored by the library. For example, the tradeoff for a sub-circuit may be represented by a graph, a chart, text, or the like. In some cases, a combination of pre-prepared implementations and dynamically generated implementations may be used for different sub-circuits of a quantum program. In other cases, all implementations used for sub-circuits of a quantum program may be either pre-prepared or dynamically generated.

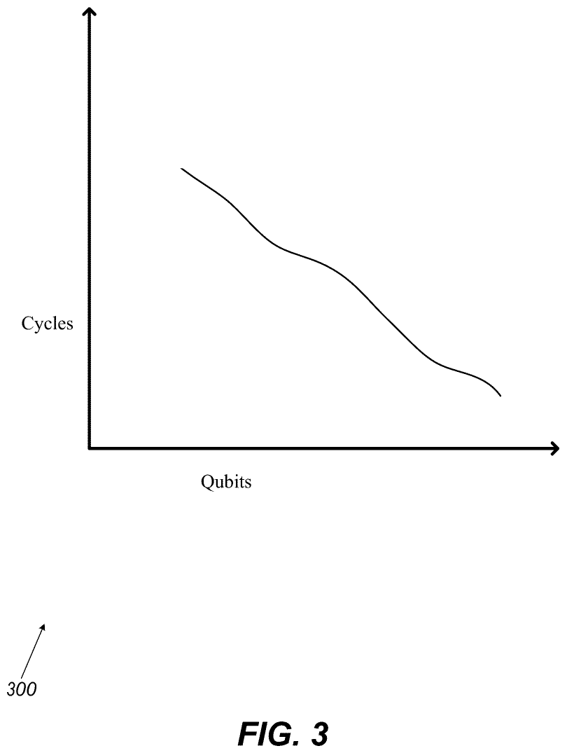

In some exemplary embodiments, in order to allow a dynamic generation of implementations, a line chart for a sub-circuit may be generated ahead of time, pre-prepared, or the like, and added to the library. In some exemplary embodiments, the line chart may represent a tradeoff between cycles and physical qubit that is applicable for the sub-circuit and/or for a generation function that is tasked with generating physical implementations of the sub-circuit. For example, an exemplary line chart is depicted in FIG. 3.

In some exemplary embodiments, the line chart may be generated over first and second axes. For example, a first axis may represent the number of cycles (corresponding to the execution time), and the second axis may represent the number of physical qubits (corresponding to the “size” of the implementation). In some cases, a line chart may be generated such that each data point in the line chart reflects a plausible implementation of the sub-circuit using values of cycles and size that correspond to the data point. In some cases, a subset of data points of the chart may correspond to physical implementations. For example, data points with X-axis values that are multiples of ten (e.g., 70, 80, 90 and so on) may correspond to physical implementations, while data points between these values (e.g., X-axis value of 83) may not have corresponding physical implementations. According to this example, not every data point on the chart may correspond to a physical implementation. In some exemplary embodiments, different data points of the chart may represent different physical implementations, e.g., without duplicates. In some exemplary embodiments, every data point that corresponds to a physical implementation may represent a different tradeoff between size and execution time, characterizing the respective physical implementation.

In some exemplary embodiments, a dynamic generation of a physical implementation of a sub-circuit may be applied on the fly, based on a selection of a data point from the chart, for the sub-circuit. In some exemplary embodiments, a selection of a data point from the line chart may correspond to a selection of a respective physical implementation that has the number of cycles and physical qubits as indicated by the values of the data point. For example, based on a selection of a data point that represents a first number of cycles and a second number of physical qubits, a physical implementation with corresponding numbers of cycles and physical qubits may be dynamically generated according to one or more methods disclosed in U.S. patent application Ser. No. 17/499,082 filed Oct. 12, 2021, titled “DYNAMIC SYNTHESIS OF GATE-LEVEL IMPLEMENTATIONS OF FUNCTIONAL BLOCKS IN QUANTUM CIRCUITS”, which is incorporated by reference herein in its entirety without giving rise to disavowment (“dynamic generation method”).

In some exemplary embodiments, a line chart may be generated for a sub-circuit in advance, and added to the library, while the data point may be selected during compilation (e.g., by the CSP solver), resulting with a dynamic generation of physical implementations during compilation. In some cases, a predictor and/or approximator may be employed to predict the error rates of implementations associated with different data point of the chart.

It is noted that when referring to a “library entry”, the disclosed subject matter relates to metadata of a pre-prepared implementation, such as a table row, or to a data point of a chart.

In some exemplary embodiments, the selection process may be performed based on a global optimization calculation. In some exemplary embodiments, the optimization function may utilize one or more optimizers such as CSP solvers, search algorithms, heuristic algorithms, constraint solvers, predictors, or the like. In some exemplary embodiments, the selection process may be performed based on library entries.

In some exemplary embodiments, the optimization calculation may define a CSP that corresponds to the quantum circuit, and comprises variables, domains and constraints. According to this example, the global and local constraints may be added to the CSP problem as constraints, and the domains of the parameters may be adjusted to correspond to the constraints, to user settings, to properties of the quantum execution platform, to properties of the quantum circuit, or the like.

In some exemplary embodiments, the optimization function may utilize a CSP solver to solve the CSP. In some exemplary embodiments, the optimization function, e.g., using a CSP solver, may be configured to output at least one set of valuations for the set of parameters that complies with all the constraints, and optimizes globally on the objective function. For example, the optimization function may be implemented by a constraint solver that is configured to provide indices of library entries for each sub-circuit, such that the associated physical implementations comply with all of the constraints of the quantum execution platform and the quantum circuit, while reducing a weighted or non-weighted cost function. In other cases, any other optimizer or constraint solver may be utilized in addition to or instead the CSP solver.

In some cases, the optimization function may employ one or more search algorithms in order to determine an optimal selection of library entries. For example, the search algorithms may be employed in a solution space that includes the library entries of all the sub-circuits in a program, searching for a valuation of library entry selections that complies with the constraints and optimizes on the number of cycles, e.g., globally. In some cases, a search algorithm may be configured to terminate upon finding one or more sets of valuations for library entry selections that comply with the constraints and domains, and may be considered optimal according to an objective function.

In some exemplary embodiments, the optimization function may be configured to select library entries that optimize globally, even if not locally. For example, in case a data point from a line chart is optimized locally, e.g., has a shortest execution time while using the largest number of physical qubits that is available on the execution platform, the data point may not necessarily be selected, so that parallel execution with another sub-circuit may be enabled.

In some exemplary embodiments, the library may be generated, obtained, updated, adjusted, or the like. For example, implementations of a sub-circuit may be generated, statically or dynamically, according to an error correction design corresponding to the topological design method, and added to the library. As another example, implementations of a sub-circuit may be generated, statically or dynamically, according to an error correction design corresponding to one or more frameworks disclosed in D. Litinski. “A Game of Surface Codes: Large-Scale Quantum Computing with Lattice Surgery”. arXiv:1808.02892 (2018). arxiv.org/abs/1808.02892. As another example, implementations of a sub-circuit may be generated according to the dynamic generation method. As another example, implementations of a sub-circuit may be generated according to the CSP generation method, such as by generating CSPs with various hardware constraints (e.g., all of which complying with the constraints of the quantum circuit), solving them, and using the valuations from the CSP solver to synthesize implementations. As another example, implementations of a sub-circuit may be generated using a parameterized circuit design process, adaptive circuit compilation, modular sub-circuit swapping, constraint-guided circuit transformations, or the like.

In some exemplary embodiments, the library may be generated to incorporate one or more line charts for one or more respective sub-circuits. For example, a line chart may be generated by synthesizing a plurality of physical implementations of the sub-circuit, e.g., according to any of the above methods, measuring the performance of the different implementations, and generating the line chart to match the measured performance. For example, in order to provide a continuous line chart, or a line chart with discrete intervals, data point values may be extrapolated based on the existing data point values. In some cases, the extrapolation may be performed using one or more approximation functions such as machine learning predictors, data augmentation, simulated annealing, or the like. In some exemplary embodiments, a line chart may be generated or obtained in any other way.

In some exemplary embodiments, instead of using a line chart, a textual or numeral representation of the line chart may generated and added to the library. The representation of the line chart may also be referred to as the line chart.

On Step 120, based on the selection of physical implementations for each sub-circuit, the quantum circuit may be synthesized. In some exemplary embodiments, the selected library entries may represent a selection of one or more pre-prepared physical implementations, a selection of one or more data points from line charts, a combination thereof, or the like.

In some exemplary embodiments, for each selected library entry, a corresponding physical implementation may be retrieved, obtained, generated, or the like. In some exemplary embodiments, the physical implementations of the sub-circuits may be aggregated, combined, or the like. For example, glue code may be applied in case consecutive physical implementations utilize different error correction schemes, e.g., different sizes of qubit patches.

On Step 130, the synthesized quantum circuit may be executed on the quantum execution platform, e.g., on a quantum computer, a quantum cloud, or the like.

Referring now to FIGS. 2A-2C, depicting exemplary scenarios of implementation selections, in accordance with some exemplary embodiments of the disclosed subject matter.

FIG. 2A depicts exemplary sub-circuits of a quantum program, e.g., Program 200. In some exemplary embodiments, Sub-circuits 210, 220, and 230 (denoted “FU1”, “FU2”, and “FU3”) may comprise respective functions of a high-level representation. In some exemplary embodiments, the high-level representation may be representable by a DAG, indicating precedence constraints between Sub-circuits 210, 220, and 230. For example, the precedence constraints may indicate that Sub-circuits 210 and 220 must complete their execution before the execution of Sub-circuit 230 starts. For example, this may be the case if Sub-circuit 230 obtains as input the outputs from Sub-circuits 210 and 220.

In some exemplary embodiments, Sub-circuits 210, 220, and 230 are illustrated as rectangles for simplicity of representation, but could take any other shape. For example, Sub-circuits 210, 220, and 230 may take non-rectangle shapes that are separate or intertwined with one another. For example, Sub-circuit 210 may utilize qubits of indices 0 and 2, and Sub-circuit 220 may utilize qubits of indices 1 and 3, resulting with an intertwined shape.

In some exemplary embodiments, each sub-circuit may correspond to a plurality of metadata entries, corresponding to respective physical implementations. For example, exemplary metadata entries of physical implementations of Sub-circuit 210 are shown in Table 2, and exemplary metadata entries of physical implementations of Sub-circuit 220 are shown in Table 3, e.g., as follows.

TABLE 2

| | Total design size in | Total time in |
|---|---|---|
| # T-factories | physical qubits | cycles |
| 1 | 72000 | 200000 |
| 2 | 80000 | 110000 |
| 3 | 88000 | 70000 |
| 4 | 96000 | 65000 |
| 5 | 104000 | 63000 |

TABLE 3

| | Total design size in | Total time in |
|---|---|---|
| # T-factories | physical qubits | cycles |
| 1 | 40000 | 1100000 |
| 2 | 45000 | 90000 |
| 3 | 50000 | 70000 |
| 4 | 55000 | 65000 |
| 5 | 60000 | 62000 |

In some exemplary embodiments, the metadata entries of Tables 2 and 3 may or may not be, partially or fully, stored in the library. In one example, in case the entries are stored in the library, a selection process may be configured to select a library entry for Sub-circuit 210 from Table 2, and a library entry for Sub-circuit 220 from Table 3.

In some exemplary embodiments, in order to reduce an overall execution time of Program 200, e.g., Execution Time 240, one or more algorithms or techniques may be employed. In some exemplary embodiments, performing the selection process using local or greedy optimizations, may provide sub-optimal results. For example, FIG. 2B depicts a scenario in which a local optimizer selects, for Sub-circuits 210 and 220, a locally optimal entry that optimizes locally on the execution time.

According to this example, the local optimizer may select for Sub-circuit 210, from Table 2, a library entry of 104,000 physical qubits and 63,000 cycles, e.g., since the number of cycles is minimal compared to other table entries. According to this example, the local optimizer may select for Sub-circuit 220, from Table 3, a library entry of 60,000 physical qubits and 62,000 cycles, e.g., since the number of cycles is minimal compared to other table entries.

In some exemplary embodiments, although the selection may be locally optimized, it may not be globally optimized. For example, in case of the above selection of physical implementations, the execution platform may not have sufficient physical qubits for executing Sub-circuits 210 and 220 in parallel, e.g., since the execution platform may not have 164,000 available physical qubits. According to this example, Sub-circuits 210 and 220 will be executed subsequently, resulting with an Execution Time 242 including 125,000 cycles for Sub-circuits 210 and 220 (62,000 cycles+63,000 cycles), and with an increased error rate of Sub-circuit 210 incurred from waiting 62,000 cycles for the execution of Sub-circuit 220 to be completed.

In some exemplary embodiments, in order to overcome this drawback, the selection process may be configured to optimize globally, e.g., as depicted in FIG. 2C.

In some exemplary embodiments, instead of using local or greedy algorithms, the selection of library entries may be performed according to one or more global optimizers such as CSP solvers or search algorithms. In some exemplary embodiments, a globally optimal selection of library entries may be determined by a global optimizer, such as by taking into account precedence constraints between the sub-circuits, and a global reduction in Execution Time 240. In some exemplary embodiments, a globally optimal selection may be performed in order to reduce the number of cycles as much as possible, while ensuring that the total number of physical qubits allocated to implementations at each cycle, complies with the global constraint on physical qubits.

In some exemplary embodiments, in order to reduce Execution Time 240, a CSP solver may select library entries that result with a reduced execution time, e.g., Execution Time 244. For example, Execution Time 244 may be selected such that it is reduced compared to Execution Time 242 of FIG. 2B.

In some exemplary embodiments, the CSP solver may select to divide the number of available physical between Sub-circuits 210 and 220, in order to enable parallel execution. In some exemplary embodiments, the CSP solver may select library entries that reduce the execution time of both Sub-circuits 210 and 220, while enabling a parallel execution. In some exemplary embodiments, the CSP solver may select the maximal numbers of physical for Sub-circuits 210 and 220, that still enable parallel execution.

For example, in case the hardware constraints of the execution platform allow for 138,000 qubits, but not for 151,000 qubits, the CSP solver may select for Sub-circuit 210 a library entry of 88,000 physical qubits and 70,000 cycles, e.g., from Table 2, and select for Sub-circuit 220 a library entry of 50,000 physical qubits and 70,000 cycles, e.g., from Table 3. According to this example, the selection may result with a reduced Execution Time 244 for Sub-circuits 210 and 220 of 70,000 cycles, e.g., which may be reduced compared to 125,000 cycles for Sub-circuits 210 and 220 in Execution Time 242. Since the execution time is reduced, the number of idle cycles is reduced accordingly, resulting with lower error rates.

In some exemplary embodiments, any other global optimizer may be used in addition to or instead of the CSP solver, and may be configured to reduce the execution time, to obtain a desired balance between time in cycles, to reduce the number of physical qubits, or the like. In some exemplary embodiments, the selection process may be configured to comply with constraints such as hardware constraints.

In some cases, in case one or more sub-circuits have a single library entry, the selection of the library entry may be made by default, e.g., before an optimization calculation, and may be added as a constraint to the CSP.

Referring now to FIG. 3, depicting an exemplary line chart, in accordance with some exemplary embodiments of the disclosed subject matter.

As depicted in FIG. 3, library entries of a sub-circuit may comprise data points of a chart, such as data points of Chart 300. In some exemplary embodiments, Chart 300 may be generated, obtained, or the like, and added to the library. In some cases, charts such as Chart 300 may be stored separately or together with library entries that correspond to pre-prepared implementations.

In some exemplary embodiments, Chart 300 may represent the tradeoff between qubits and cycles, for a specific sub-circuit. In some exemplary embodiments, at least a portion of data points on Chart 300 may represent a respective physical implementation of the sub-circuit. In some exemplary embodiments, each represented physical implementation may feature a different qubits-to-cycles ratio that corresponds to properties of a respective physical implementation of the sub-circuit. As depicted in FIG. 3, as the number of qubits is increased (e.g., potentially increasing the number of T-factories), the number of cycles is reduced.

In some exemplary embodiments, the line of Chart 300 may start at a point of the qubit axis that corresponds to the minimal number of qubits of the implementations of the sub-circuit (e.g., not at the origin or intersection point of the axes). For example, in the example of Table 2, the line of Chart 300 may start at 72,000 qubits. As another example, in the example of Table 3, the line of Chart 300 may start at 40,000 qubits.

In some exemplary embodiments, Chart 300 may be continuous, partially continuous, have discrete intervals, or the like. For example, every consecutive data point may be separated by 4,000 physical qubits, 2,000 physical qubits, a single physical qubit, or the like. As another example, in case a point on the qubit graph does not correspond to a feasible physical implementation, the data point may be removed from Chart 300, resulting with a discontinuous graph.

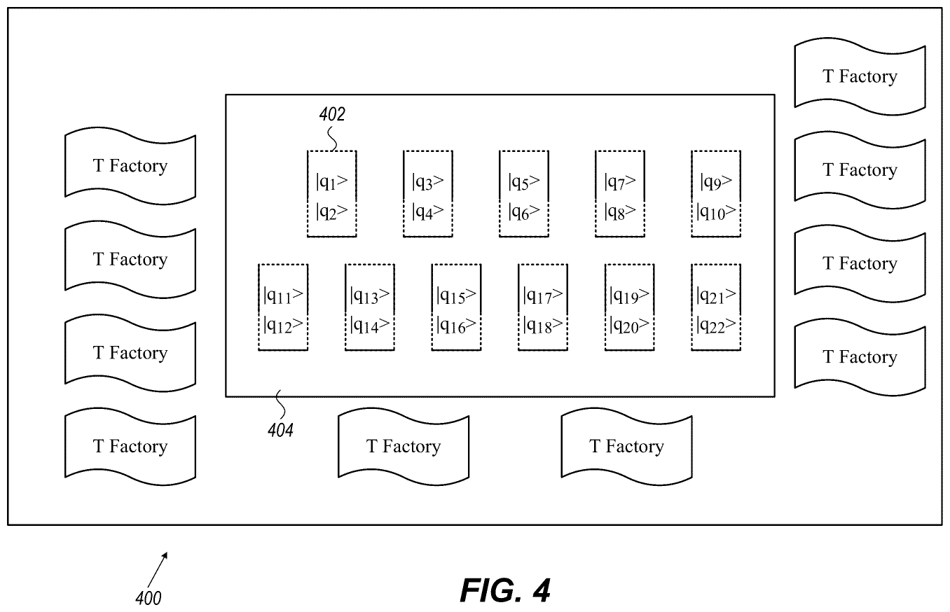

Referring now to FIG. 4, depicting an exemplary physical implementation of a sub-circuit, in accordance with some exemplary embodiments of the disclosed subject matter.

In some exemplary embodiments, every library entry may comprise metadata that relates to a single physical implementation, such as Physical Implementation 400. In some exemplary embodiments, Physical Implementation 400 may implement a sub-circuit (e.g., a function, one or more DAG nodes, or the like) according to one or more logical representations of the sub-circuit, one or more error correction frameworks, or the like, to which the selection process may be agnostic. For example, Physical Implementation 400 may implement a sub-circuit according to the topological design method.

As depicted in FIG. 4, logical qubits of the sub-circuit may be represented by two-qubit patches, e.g., Patch 402. For example, Qubit Patch 402 may comprise a 2-qubit patch that is configured to represent two logical qubits of the sub-circuit, using a selected number of physical qubits. In some cases, an auxiliary region, e.g., Auxiliary Patch 404, may be generated between and around the qubit patches, as depicted in FIG. 4. Auxiliary Patch 404 may comprise a region (Auxiliary Patch 404) that surrounds all the qubit patches and provides a full connectivity of the qubit patches with one another, through respective paths. In some cases, Auxiliary Patch 404 may enable application of quantum operations between any two qubit patches.

In some cases, the T-factory patches, surrounding Auxiliary Patch 404, may be designed around the Auxiliary Patch 404. In some cases, T-factory implementations may correspond to those disclosed in D. Litinski. “Magic State Distillation: Not as Costly as You Think”. arXiv:1905.06903. Quantum 3, 205 (2019), which is hereby incorporated by reference in its entirety for all purposes without giving rise to disavowment. In some exemplary embodiments, T-factories may differ in their speed of generating T-state or magic states, in the quality of the generated T-states, in their qubit-wise size, in their error rates, in their execution time, in their availability on different execution platforms, or the like. In some exemplary embodiments, a tradeoff may typically exist between the size and efficiency of T-generators. For example, as a T-generator utilizes more physical qubits (e.g., increased size), its speed of T-state generation and quality of the generated T-states may be increased monotonically, and vice versa.

In some exemplary embodiments, in case a physical implementation such as Physical Implementation 400 exists for a sub-circuit, its metadata may be extracted and added as an entry to the library. In some exemplary embodiments, metadata, such as performance parameters, may be extracted from Physical Implementation 400 in one or more manners, e.g., by measuring executions thereof, approximation functions, of the like. For example, the number of physical qubits allocated to Physical Implementation 400, or any other circuit properties, may be estimated using one or more approximation functions such as Quantum Approximate Optimization Algorithm (QAOA), Approximate Quantum Fourier Transform (AQFT), Hamiltonian Simulation and Trotter-Suzuki Approximation, Variational Quantum Algorithms (VQAs), or the like.

In some exemplary embodiments, the number of physical qubits allocated to Physical Implementation 400 may be estimated based on a size of a single a qubit patch, e.g., due to the uniformity of the qubit patches in the design of Physical Implementation 400. In some exemplary embodiments, the size of the individual qubit patches may be determined according to the error limit, which can then be used to infer the number of physical qubits allocated across all qubit patches, the auxiliary patch, and the T-factory patches. In other cases, any other method may be employed to estimate the number of physical qubits assigned to a physical implementation.

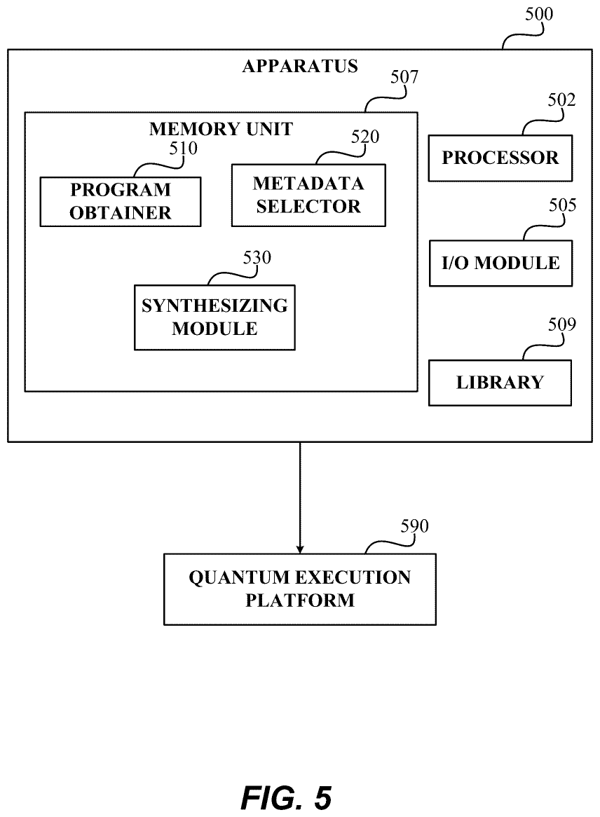

Referring now to FIG. 5 showing a block diagram of an apparatus, in accordance with some exemplary embodiments of the disclosed subject matter.

In some exemplary embodiments, Apparatus 500 may comprise one or more Processor(s) 502. Processor 502 may be a Central Processing Unit (CPU), a microprocessor, an electronic circuit, an Integrated Circuit (IC) or the like. Processor 502 may be utilized to perform computations required by Apparatus 500 or any of its subcomponents. It is noted that Processor 502 may be a traditional classical processor, and not necessarily a quantum processor.

In some exemplary embodiments of the disclosed subject matter, Apparatus 500 may comprise an Input/Output (I/O) module 505. I/O Module 505 may be utilized to provide an output to and receive input from a user, an apparatus, or the like, such as, for example to obtain a user-defined quantum program, to obtain a user-defined objective function, showing circuit illustrations, communicating with quantum hardware, or the like.

In some exemplary embodiments, Apparatus 500 may comprise, or have access to, a Library 509. Library 509 may comprise a database or repository of metadata regarding different physical implementations of high-level sub-circuits (e.g., lacking native gates). In some exemplary embodiments, Library 509 may comprise the physical implementations themselves, a generating function that is capable to dynamically generate requested physical implementations, or the like. For example, the metadata and the implementations may be stored in same or different locations, in association with one another, or the like.

In some exemplary embodiments, Apparatus 500 may comprise Memory 507. Memory 507 may be a hard disk drive, a Flash disk, a Random Access Memory (RAM), a memory chip, or the like. In some exemplary embodiments, Memory 507 may retain program code operative to cause Processor 502 to perform acts associated with any of the subcomponents of Apparatus 500. Memory 507 may comprise one or more components as detailed below, implemented as executables, libraries, static libraries, functions, or any other executable components.

In some exemplary embodiments, Memory 507 may comprise a Program Obtainer 510. Program Obtainer 510 may obtain a quantum program, e.g., a high-level representation of a quantum circuit, from a user, a server, a computing device, or the like. Program Obtainer 510 may obtain the quantum program via I/O Module 505. In some exemplary embodiments, Program Obtainer 510 may or may not obtain an error limit for the quantum program.

In some exemplary embodiments, Memory 507 may comprise a Metadata Selector 520, which may be configured to select, for each sub-circuit of the quantum program, a corresponding library entry of Library 509. In some exemplary embodiments, the library entry may comprise metadata regarding a physical implementation of the sub-circuit.

In some exemplary embodiments, Memory 507 may comprise a Synthesizing Module 530, which may be configured to synthesize a physical quantum circuit according to the selections of Metadata Selector 520. In some exemplary embodiments, Synthesizing Module 570 may aggregate the selected physical implementations according to the precedence constraints and the hardware constraints, and when needed, may add glue code to combine different error correction sizes. In some cases, the synthesized quantum circuit may be executed on Quantum Execution Platform 590, or any other execution platform. In some cases, instead of actual execution by Quantum Execution Platform 590, an execution of the synthesized quantum circuit may be simulated using an emulator, a simulator, or the like, on a classic computer.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), electrical signals transmitted through a wire, Quantum Random Access Memory (QRAM), photons, trapped ions, lasers, cold atoms, or the like.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server (or a group of multiple remote servers). In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method comprising:
obtaining a high-level representation of a quantum circuit, wherein the high-level representation is composed of a plurality of sub-circuits;
selecting a plurality of physical implementations for the plurality of sub-circuits, respectively, based on a library of physical implementation metadata, said selecting comprising selecting a physical implementation for a sub-circuit from the plurality of sub-circuits based on metadata of the physical implementation, the metadata of the physical implementation indicating a number of physical qubits used by the physical implementation and a number of physical cycles used by the physical implementation, said selecting comprising selecting the physical implementation from a plurality of alternative implementations of the sub-circuit, wherein the library comprises a respective plurality of metadata for the plurality of alternative implementations; and
synthesizing the quantum circuit according to the plurality of physical implementations, thereby obtaining a synthesized quantum circuit.

2. The method of claim 1, wherein said selecting the plurality of physical implementations is performed based on a global optimization calculation, the global optimization calculation comprises at least a hardware constraint on available physical qubits of a quantum execution platform.

3. The method of claim 2, wherein the global optimization calculation is configured to minimize at least one of: a number of cycles of the synthesized quantum circuit, a number of gates of the synthesized quantum circuit, a number of gates of a defined type used by the synthesized quantum circuit, an error rate of the synthesized quantum circuit, a number of physical qubits used by the synthesized quantum circuit, or a combination thereof.

4. The method of claim 2, wherein the global optimization calculation is configured to minimize a cost of glue code used to combine the plurality of physical implementations into the synthesized quantum circuit.

5. The method of claim 2, wherein the global optimization calculation is configured to comply with precedence constraints between the plurality of sub-circuits, and with a global error limit on the synthesized quantum circuit.

6. The method of claim 5, wherein:
the global optimization calculation defines a Constraint Satisfaction Problem (CSP) that corresponds to the high-level representation, the CSP comprises variables, domains and constraints, each variable of the variables has a corresponding domain in the domains that defines one or more potential values of the variable, the constraints define one or more constraints on values of the variables or portion thereof, the constraints comprise the precedence constraints, the global error limit, and the hardware constraint; and
the method further comprises generating the synthesized quantum circuit by utilizing a CSP solver to solve the CSP, wherein a solution of the CSP defines a selection of a plurality of library entries from the library, the plurality of library entries corresponds to the plurality of physical implementations.

7. The method of claim 1, wherein the sub-circuit is implementable by the plurality of alternative physical implementations, each of which implementing the sub-circuit and resulting with different metadata, the plurality of alternative physical implementations comprises at least the physical implementation and a second physical implementation.

8. The method of claim 7, wherein the library comprises at least second metadata regarding the second physical implementation of the sub-circuit, wherein the second metadata indicates a second number of physical qubits used by the second physical implementation and a second number of physical cycles used by the second physical implementation, wherein the second metadata differs from the metadata of the physical implementation in at least one parameter.

9. The method of claim 1, wherein the library is absent of inferior metadata entries for the sub-circuit that indicate inferior performance properties in all parameters compared to at least one metadata entry for the sub-circuit.

10. The method of claim 1, wherein said synthesizing comprises retrieving the physical implementation from a storage associated with the library.

11. The method of claim 1, wherein said selecting the physical implementation comprises selecting a data point from a line chart, the line chart representing a tradeoff of physical qubits per physical cycles for alternative physical implementations of the sub-circuit, wherein said synthesizing comprises dynamically generating the physical implementation for the data point.

12. The method of claim 1, wherein the high-level representation comprises a Directed Acyclic Graph (DAG), wherein nodes of the DAG represent the plurality of quantum operations, wherein edges between the nodes represent precedence constraints between the plurality of quantum operations, wherein each sub-circuit of the plurality of sub-circuits comprises at least one disjoint node of the nodes.

13. The method of claim 1, wherein the high-level representation comprises a high-level quantum program composed of a plurality of functions, wherein each sub-circuit of the plurality of sub-circuits comprises at least one disjoint function of the plurality of functions.

14. The method of claim 1, wherein said selecting is performed based on the metadata of the physical implementation and is agnostic to implementation details of the plurality of alternative implementations.

15. The method of claim 1 further comprising executing the synthesized quantum circuit on a quantum execution platform.

16. An apparatus comprising a processor and coupled memory, said processor being adapted to:
obtain a high-level representation of a quantum circuit, wherein the high-level representation is composed of a plurality of sub-circuits;
select a plurality of physical implementations for the plurality of sub-circuits, respectively, based on a library of physical implementation metadata, said selecting comprising selecting a physical implementation for a sub-circuit from the plurality of sub-circuits based on metadata of the physical implementation, the metadata of the physical implementation indicating a number of physical qubits used by the physical implementation and a number of physical cycles used by the physical implementation, said selecting comprising selecting the physical implementation from a plurality of alternative implementations of the sub-circuit, wherein the library comprises a respective plurality of metadata for the plurality of alternative implementations; and
synthesize the quantum circuit according to the plurality of physical implementations, thereby obtaining a synthesized quantum circuit.

17. The apparatus of claim 16, wherein said selecting the plurality of physical implementations is performed based on a global optimization calculation, the global optimization calculation comprises at least a hardware constraint on available physical qubits of a quantum execution platform.

18. The apparatus of claim 16, wherein said synthesizing comprises retrieving the physical implementation from a storage associated with the library.

19. The apparatus of claim 16, wherein said selecting the physical implementation comprises selecting a data point from a line chart, the line chart representing a tradeoff of physical qubits per physical cycles for alternative physical implementations of the sub-circuit, wherein said synthesizing comprises dynamically generating the physical implementation for the data point.

20. A computer program product comprising a non-transitory computer readable medium retaining program instructions, which program instructions when read by a processor, cause the processor to:
obtain a high-level representation of a quantum circuit, wherein the high-level representation is composed of a plurality of sub-circuits;
select a plurality of physical implementations for the plurality of sub-circuits, respectively, based on a library of physical implementation metadata, said selecting comprising selecting a physical implementation for a sub-circuit from the plurality of sub-circuits based on metadata of the physical implementation, the metadata of the physical implementation indicating a number of physical qubits used by the physical implementation and a number of physical cycles used by the physical implementation, said selecting comprising selecting the physical implementation from a plurality of alternative implementations of the sub-circuit, wherein the library comprises a respective plurality of metadata for the plurality of alternative implementations; and
synthesize the quantum circuit according to the plurality of physical implementations, thereby obtaining a synthesized quantum circuit.
